(19) United States
(12) Patent Application Publication
(10) Pub. No.: US 2010/0097736 A1
(43) Pub. Date: Apr. 22, 2010

(54) METHOD AND AN APPARATUS FOR PROTECTING A BUS IN A THREE-PHASE ELECTRICAL POWER SYSTEM

(76) Inventors: Alexander Apostolov, Los Angeles, CA (US); Roland Passet, Montpellier (FR); Frederic Auperrin, Laverune (FR); Damien Tholomier, Outremont (CA)

Correspondence Address: Nixon Peabody LLP, P.O. Box 60610, Palo Alto, CA, 94306, US

(21) Appl. No.: 12/519,139

(22) PCT Filed: Dec. 14, 2006
(86) PCT No.: PCT/GB06/04702

§ 371 Date: Dec. 15, 2009

(51) Int. Cl. H02H 3/38

(52) U.S. Cl. 361/79

(57) ABSTRACT

A method of protecting a bus in a three-phase electrical power system comprises the steps of (a) sampling voltage values and current values of each phase of the or each power system element within a predefined protection zone; (b) analysing at least one sampled voltage value of each phase of a power system element within the protection zone to detect when a fault condition arises; (c) on detection of a fault condition, determining whether the fault condition has arisen because of a bus fault; and (d) electrically isolating the bus from the or each power system element within the protection zone when a bus fault is determined so as to clear the bus fault.

### CROSS REFERENCE TO RELATED APPLICATIONS OR PRIORITY CLAIM

This application is a national phase of International Application No. PCT/GB2006/004702, entitled “A METHOD AND AN APPARATUS FOR PROTECTING A BUS IN A THREE-PHASE ELECTRICAL POWER SYSTEM”, which was filed on Dec. 14, 2006.

### DESCRIPTION

### Technical Field and Prior Art

This invention relates in particular, but not exclusively, to a method of protecting a bus in a three-phase electrical power system. The invention also relates to an apparatus for protecting a bus in a three-phase electrical power system.

In electrical power transmission and distribution systems a bus, e.g. in a substation, is associated with one or more power system elements such as a line, a feeder and a transformer. It is necessary to protect the bus against short-circuits and other faults because a bus fault can have a catastrophic effect on the stability of the electrical power system. As a result, fast clearing of a bus fault is highly desirable.

One method of conventional bus protection is high impedance differential bus protection, which is based on a circulating current principle.

A relay that includes a resistor responds to a voltage across differential junction points on secondary windings of low leakage impedance current transformers to electrically isolate the bus on detection of a bus fault. Such a fault causes an imbalance of circulating currents between power system elements in the bus. This imbalance is represented as voltage bias across the resistor of the relay. Shorting links across the resistor are used to set the level of voltage bias that actuates the relay to isolate the bus.

One drawback with this arrangement is that the relay is only able to isolate one zone of the bus.

Furthermore, high impedance differential protection requires the installation of additional equipment such as combiner wiring box. Such equipment requires periodic maintenance of, e.g. wiring terminals, as well as systems calibration to assure reliability.

In addition, high impedance differential protection is applicable only to a bus having a fixed configuration and requires a voltage limiting varistor capable of absorbing significant energy during bus faults. Consequently, high impedance differential protection is inflexible and its use makes it extremely difficult to readily reconfigure the bus and assure high reliability and sensitivity.

Another drawback of high impedance differential protection is that each of the current transformers associated with a given power system element must have the same current transformer ratio and similar current transformer characteristics.

Another method of conventional bus protection is centralized low impedance bus differential protection. This method involves using a current transformer to sample a current value of each phase of each power system element associated with the bus during each cycle of operation.

A circuit associated with each current transformer determines the magnitude and angle of a current vector for each power system element. The sum of the current vectors gives the differential current for the bus. The circuit then compares the differential current with a predetermined bus operating characteristic in order to determine whether a bus fault has occurred. On determination of a bus fault the bus is electrically isolated in order to clear the fault. The calculation of each current vector is typically based on sampled current values which are taken over one complete cycle. This results in a delay in determining whether a bus fault has occurred.

The introduction of such a delay allows sufficient time for a current transformer to become saturated, e.g. in the event of an external fault beyond the bus, thereby resulting in erroneous determination of a bus fault. Consequently it is necessary to carry out an additional check to determine whether current transformer saturation has occurred in order to prevent erroneous determination of a bus fault.

It is also necessary to determine the bus operating characteristic according to the configuration of the bus, i.e. according to the zone of the bus which it is desired to protect. In addition, each of the current transformers associated with a given power system element may require the same current transformer ratio and similar current transformer characteristics. Consequently, centralized low impedance differential protection is inflexible and its use makes it extremely difficult to readily reconfigure the bus.

A further method of conventional bus protection is decentralized low impedance differential protection.

Decentralized low impedance differential protection reduces the processing burden on a central processing unit by using remote current transformer units. Each remote current transformer unit calculates the current vector for a respective power system element and transmits a digitized current value to the central processing unit which performs the necessary differential current calculation. The reduction in the processing burden shortens the delay in determining whether a bus fault has occurred, However, each remote current transformer unit must still obtain sampled values over one complete cycle in order to calculate the current vector. Consequently there is still a significant delay in determining whether a bus fault has occurred. As a result there is still an opportunity for current transformer saturation to occur and so it remains necessary to check whether current transformer saturation has occurred.

A further drawback of decentralized low impedance differential protection is that the operation of the remote current transformer units must be accurately synchronised with one another. This is because any timing error will result in a phase shift which will alter the differential current, which may result in an incorrect determination of a bus fault and therefore undesired isolation of the bus.

Each of high impedance differential protection, centralized low impedance differential protection, and decentralized low impedance differential protection requires dedicated hardware which must be installed and maintained. This results in a high overall cost for implementing each such method.

Therefore, there is a need for an improved method and apparatus for protecting a bus in a three-phase electrical power system which obviate the aforementioned problems with conventional protection techniques.

A first aspect of the invention provides a method of protecting a bus in a three-phase electrical power system, the bus having at least one power system element associated therewith, the method comprising the steps of:

(a) sampling voltage values and current values of each phase of the or each power system element within a predefined protection zone;

(b) analysing at least one sampled voltage value of each phase of a power system element within the protection zone to detect when a fault condition arises;

(c) on detection of a fault condition, determining whether the fault condition has arisen because of a bus fault; and

(d) electrically isolating the bus from the or each power system element within the protection zone when a bus fault is determined so as to clear the bus fault.

The detection of a fault condition and the determination of whether the fault condition has arisen because of a bus fault obviates the need to obtain samples of current values over a complete cycle, and thereby reduces the delay in determining whether a bus fault has actually occurred. There is also no need to carry out an additional check to determine whether current transformer saturation has occurred.

In addition, the method of the invention obviates the need to install, commission and maintain dedicated bus differential protection hardware, thereby reducing considerably the cost of implementing bus protection.

Preferably the method further includes the steps of:

establishing the status of a circuit breaker interconnected between the bus and the or each power system element associated therewith to determine whether the or each power system element is electrically connected with the bus; and

defining the protection zone to include the or each power system element which is electrically connected with the bus.

In this way the method of the invention is readily able to adapt to changes in the bus configuration which may arise, e.g. as a result of changes in the configuration of a substation.

Optionally determining whether the fault condition has arisen because of a bus fault includes determining a fault direction relative to the bus for the or each power system element within the protection zone, a fault direction from the bus to a given power system element indicating a fault with the given power system element.

Conveniently determining a fault direction relative to the bus for the or each power system element within the protection zone includes the steps of:

retaining at least the previously sampled voltage value and current value of each phase of a given power system element within the protection zone; and

calculating a superimposed voltage component from the or each retained voltage value and the sampled voltage value of each phase, and a superimposed current component from the or each retained current value and the sampled current value of each phase.

Fault direction determination for the or each power system element is very quick at less than ⅛ of a cycle and so it is possible to determine whether a bus fault has occurred before a current transformer has had time to saturate.

In addition, determining the fault direction for the or each power system element does not involve a comparison with a predetermined operating characteristic of the bus, thereby allowing for reconfiguration of the bus without the need to recalculate the operating characteristic thereof.

Furthermore, determining the fault direction for the or each power system element is based only on voltage and current samples from a given power system element. As a result the samples from respective power system elements do not need to be accurately synchronised with one another, thereby reducing the need for accurate time synchronisation compared to, e.g. high or low impedance bus differential protection.

A preferred method according to the invention further includes the step of comparing the polarities of the superimposed voltage component and the superimposed current component, differing polarities indicating a fault direction from the bus to the given power system element, thereby indicating a fault with the given power system element. This is a convenient way of determining each fault direction and whether a bus fault has occurred.

Another preferred method according to the invention further includes the step of deriving the transient energy from the superimposed voltage component and the superimposed current component, a negative transient energy indicating a fault direction from the bus to the given power system element, thereby indicating a fault with the given power system element. Such a method allows for accurate fault direction detection under varying system conditions and is not affected by series compensated transmission lines or mutual coupling.

Preferably detecting when a fault condition arises includes the steps of:

comparing the magnitude of the sampled voltage value of each phase of a power system element within the protection zone with a predetermined low value; and

indicating a fault condition when the sampled voltage value of one phase of the power system element is less than the predetermined low value.

Optionally detecting when a fault condition arises includes the steps of:

retaining at least one cycle of previously sampled voltage values of each phase of a power system element within the protection zone; and

calculating a superimposed voltage component from the or each retained voltage value and the sampled voltage value of each phase of the power system element; and

indicating a fault condition when the superimposed voltage component is greater than a predetermined high value.

Each of the foregoing methods provides a fast and convenient way of detecting when a fault condition arises.

In another preferred method of the invention electrically isolating the bus from the or each power system element within the protection zone includes tripping a circuit breaker interconnected between the bus and the or each power system element within the protection zone. This is a quick and effective way of electrically isolating the bus from the or each power system element within the protection zone.

Conveniently the method of the invention further includes the step of recording the sampled voltage values and current values of each phase of the or each power system element within the protection zone following detection of a fault condition. Such recording allows for subsequent analysis of the fault condition.

Preferably the method of the invention further includes saving the recorded voltage and current values as a COMTRADE file so as to permit later extraction using a file transfer service.

According to a second aspect of the invention there is provided an apparatus for protecting a bus in a three-phase electrical power system, the bus having at least one power system element associated therewith, the apparatus comprising:

a respective interface unit corresponding to the or each power system element within a predefined protection zone for sampling voltage values and current values of each phase of the corresponding power system element; and

a bus protection unit in communication with the or each interface unit, the bus protection unit being for:

(a) analysing at least one sampled voltage value of each phase of a power system element the protection zone to detect when a fault condition arises;

(b) on detection of a fault condition, determining whether the fault condition has arisen because of a bus fault; and

(c) electrically isolating the bus from the or each power system element the protection zone when a bus fault is determined so as to clear the bus fault.

The apparatus shares the advantages of the method of the invention.

Preferably the or each interface unit further includes a status unit for establishing the status of a circuit breaker interconnected between the bus and the corresponding power system element, the status of the or each circuit breaker enabling the bus protection unit to (i) determine whether the corresponding power system element is electrically connected with the bus, and (ii) define the protection zone so as to include the or each power system element which is electrically connected with the bus. This allows the apparatus to readily adapt to changes in the configuration of the bus.

In a preferred embodiment of the invention the or each interface unit is remote from the bus protection unit and a communications link exists therebetween. This helps to reduce the overall cost of installing and maintaining the apparatus of the invention.

Optionally the bus protection unit further includes a buffer for retaining one or more of (i) at least the previously sampled voltage value; and (ii) at least the previously sampled current value. The inclusion of such a buffer facilitates subsequent use of the retained voltage and current values.

There now follows a brief description of a preferred embodiment of the invention, by way of non-limiting example, with reference being made to the accompanying drawings in which:

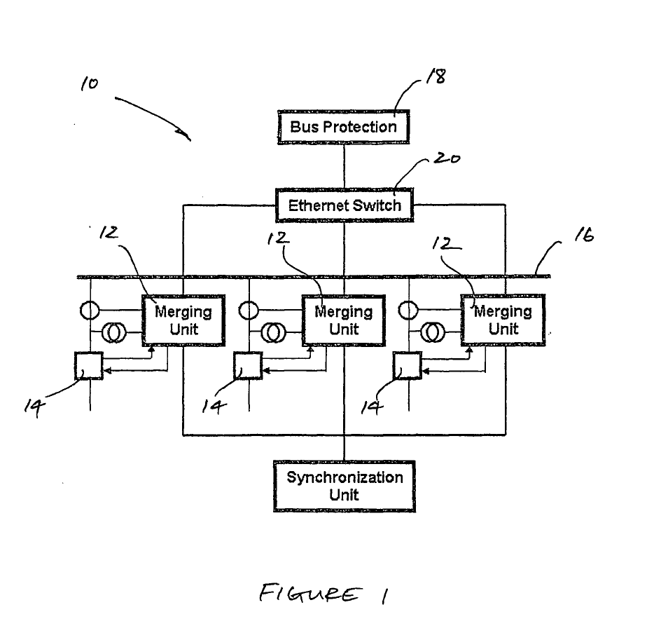

FIG. 1 shows a schematic view of an apparatus according to one embodiment of the invention; and

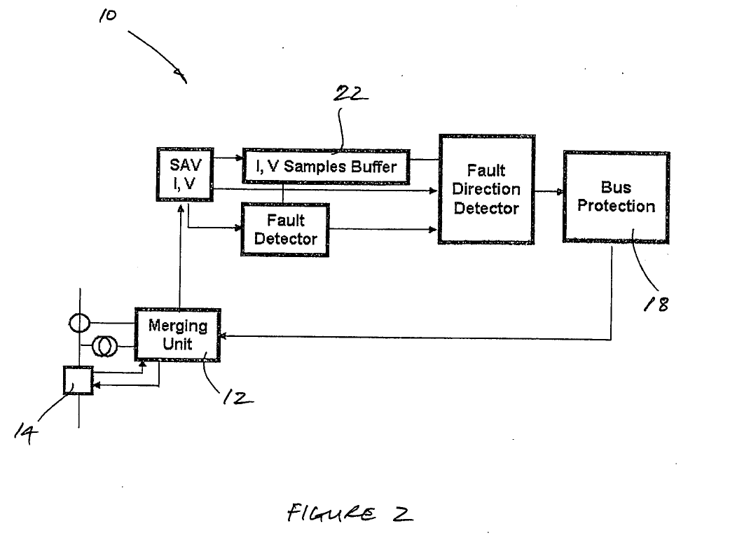

FIG. 2 shows an enlarged schematic view of one portion of FIG. 1.

An apparatus for protecting a bus in a three-phase electrical power system according to a preferred embodiment of the invention is designated generally by the reference numeral 10.

The bus protection apparatus 10 includes a plurality of interface units 12 (three in the embodiment shown schematically in FIG. 1), each of which is connected with a given power system element 14 which is associated with the bus 16.

The bus protection apparatus 10 also includes a bus protection unit 18 which is in communication with each interface unit 12. In a preferred embodiment of the invention the bus protection unit 18 includes a substation computer device (not shown) which has industrial grade characteristics and no moving parts. A preferred communication link between each interface unit 12 and the bus protection unit 18 includes an Ethernet network which has an Ethernet switch 20 for switching signals between the various units. The Ethernet network may operate at 100 Mb/sec, 1 Gb/sec or higher depending on the number of interface units 12 that the bus protection unit 18 must communicate with.

Each interface unit 12 includes a status unit (not shown) which is in electrical communication with a circuit breaker (not shown) interconnected between the bus 16 and the corresponding power system element 14.

The bus protection unit 18 also includes a buffer 22.

The bus protection apparatus 10 may also include a synchronisation unit 20 for controlling the operation of each interface unit 12.

In use, each status unit establishes the status of the circuit breaker interconnected between the bus 16 and a given power system element 14. This enables the bus protection unit 18 to determine whether the power system element 14 is electrically connected with the bus 16. The bus protection unit 18 is then able to define a protection zone to include each power system element 14 which is electrically connected with the bus 16.

Each interface unit 12 samples voltage values and current values of each phase of the corresponding power system element 14 within the protection zone.

The bus protection unit 18 analyses at least one sampled voltage value of each phase of one power system element 14 within the protection zone to detect when a fault condition arises.

On detection of a fault condition, the bus protection unit 18 determines whether the fault condition has arisen because of a bus fault. The bus protection unit 18 electrically isolates the bus 16 from each power system element 14 within the protection zone when a bus fault is determined. In one embodiment of the method of the invention, the bus protection unit 18 electrically isolates the bus 16 from each power system element 14 within the protection zone by tripping a circuit breaker between the bus 16 and each power system element 14 within the protection zone.

The bus protection unit 18 also records the sampled voltage values and current values of each phase of each power system element 14 within the protection zone following detection of a fault condition. The bus protection unit 18 saves the recorded voltage and current values as a COMTRADE file, thereby permitting later extraction using a file transfer service.

A preferred way of determining whether a fault condition has arisen because of a bus fault includes determining a fault direction relative to the bus 16 for each power system element 14 within the protection zone. This includes retaining the previously sampled voltage value and current value of each phase of each power system element 14 within the protection zone in the buffer; and calculating a superimposed voltage component from the retained voltage value and the sampled voltage value of each phase, and a superimposed current component from the retained current value and the sampled current value.

The superimposed voltage and current components are calculated using known methods commonly used in electrical power system analysis.

The bus protection unit 18 may then compare the polarities of the superimposed voltage and current components, differing polarities indicating a fault direction from the bus to the given power system element 14, thereby indicating a fault with the power system element 14. In the event of a bus fault, the fault direction is either from the power system element 14 to the bus 16, or there is no fault direction (if there is no source at a remote end of the power system element 14).

As an alternative, the bus protection unit 18 may derive the transient energy from the superimposed voltage component and the superimposed current component, a negative transient energy indicating a fault direction from the bus 16 to the given power system element 14, thereby indicating a fault with the power system element 14. A positive transient energy indicates a fault direction from the power system element 14 to the bus 16, and no transient energy indicates that there is no voltage and current source at a remote end of the power system element 14, both of which mean there is a bus fault.

A preferred way of detecting when a fault condition arises includes comparing the magnitude of the sampled voltage value of each phase of each power system element 14 within the protection zone with a predetermined low value, and indicating a fault condition when the sampled voltage value of one phase of a given power system element 14 is less than the predetermined low value.

As an alternative, detecting when a fault condition arises may include the steps of retaining the previously sampled voltage value of each phase of each power system element 14 in the protection zone in the buffer; calculating a superimposed voltage from the retained voltage value and the sampled voltage value of each phase of each power system element 14; and indicating a fault condition when the superimposed voltage component is greater than a predetermined high value.

1. A method of protecting a bus in a three-phase electrical power system, the bus having at least one power system element associated therewith, the method comprising the steps of:
(a) sampling voltage values and current values of each phase of the or each power system element within a predefined protection zone;
(b) analysing at least one sampled voltage value of each phase of a power system element within the protection zone to detect when a fault condition arises;
(c) on detection of a fault condition, determining whether the fault condition has arisen because of a bus fault; and
(d) electrically isolating the bus from the or each power system element within the protection zone when a bus fault is determined so as to clear the bus fault.
(e) establishing the status of a circuit breaker interconnected between the bus and the or each power system element associated therewith to determine whether the or each power system element is electrically connected with the bus; and
(f) defining the protection zone to include the or each power system element which is electrically connected with the bus.

2. A method according to claim 1 wherein determining whether the fault condition has arisen because of a bus fault includes determining a fault direction relative to the bus for the or each power system element within the protection zone, a fault direction from the bus to a given power system element indicating a fault with the given power system element.

3. A method according to claim 2 wherein determining a fault direction relative to the bus for the or each power system element within the protection zone includes the steps of:
retaining at least the previously sampled voltage value and current value of each phase of a given power system element within the protection zone; and
calculating a superimposed voltage component from the or each retained voltage value and the sampled voltage value of each phase, and a superimposed current component from the or each retained current value and the sampled current value of each phase.

4. A method according to claim 3 further including the step of comparing the polarities of the superimposed voltage component and the superimposed current component, differing polarities indicating a fault direction from the bus to the given power system element, thereby indicating a fault with the given power system element.

5. A method according to claim 3 further including the step of deriving the transient energy from the superimposed voltage component and the superimposed current component, a negative transient energy indicating a fault direction from the bus to the given power system element, thereby indicating a fault with the given power system element.

6. A method according to claim 1, wherein detecting when a fault condition arises includes the steps of:
comparing the magnitude of the sampled voltage value of each phase of a power system element within the protection zone with a predetermined low value; and
indicating a fault condition when the sampled voltage value of one phase of the power system element is less than the predetermined low value.

7. A method according to claim 1, wherein detecting when a fault condition arises includes the steps of:
retaining at least one cycle of previously sampled voltage values of each phase of a power system element within the protection zone; and
calculating a superimposed voltage component from the or each retained voltage value and the sampled voltage value of each phase of the power system element; and
indicating a fault condition when the superimposed voltage component is greater than a predetermined high value.

8. A method according to claim 1, wherein electrically isolating the bus from the or each power system element within the protection zone includes tripping a circuit breaker interconnected between the bus and the or each power system element within the protection zone.

9. A method according to claim 1 further including the step of recording the sampled voltage values and current values of each phase of the or each power system element within the protection zone following detection of a fault condition.

10. A method according to claim 9 further including saving the recorded voltage and current values as a COMTRADE file so as to permit later extraction using a file transfer service.

11. An apparatus for protecting a bus in a three-phase electrical power system, the bus having at least one power system element associated therewith, the apparatus comprising:
a respective interface unit corresponding to the or each power system element within a predefined protection zone for sampling voltage values and current values of each phase of the corresponding power system element; and
a bus protection unit in communication with the or each interface unit, the bus protection unit being for:
(a) analysing at least one sampled voltage value of each phase of a power system element the protection zone to detect when a fault condition arises;
(b) on detection of a fault condition, determining whether the fault condition has arisen because of a bus fault; and
(c) electrically isolating the bus from the or each power system element the protection zone when a bus fault is determined so as to clear the bus fault.

12. An apparatus according to claim 11 wherein the or each interface unit further includes a status unit for establishing the status of a circuit breaker interconnected between the bus and the corresponding power system element, the status of the or each circuit breaker enabling the bus protection unit to (i) determine whether the corresponding power system element is electrically connected with the bus, and (ii) define the protection zone so as to include the or each power system element which is electrically connected with the bus, and wherein the or each interface unit is remote from the bus protection unit and a communications link exists therebetween.

13. An apparatus according to claim 11, wherein the bus protection unit further includes a buffer for retaining one or more of (i) at least the previously sampled voltage value; and (ii) at least the previously sampled current value.

14. An apparatus according to claim 12, wherein the bus protection unit further includes a buffer for retaining one or more of (i) at least the previously sampled voltage value; and (ii) at least the previously sampled current value.
